(19) United States
(12) Patent Application Publication
(10) Pub. No.: US 2026/0291559 A1
(43) Pub. Date: Sep. 24, 2026

(54) PRECODING MATRIX INDICATION METHOD AND APPARATUS, AND INDICATION INFORMATION RECEIVING METHOD AND APPARATUS

(71) Applicant: Beijing Xiaomi Mobile Software Co., Ltd., Beijing (CN)

(72) Inventors: Liangang CHI, Beijing (CN); Li YANG, Beijing (CN); Gaoming DUAN, Beijing (CN)

(73) Assignee: Beijing Xiaomi Mobile Software Co., Ltd., Beijing (CN)

(21) Appl. No.: 19/474,872

(22) PCT Filed: Apr. 13, 2023
(86) PCT No.: PCT/CN2023/088211

§ 371 Date: Oct. 13, 2025

(51) Int. Cl. H04B 7/0456; H04L 27/26

(52) U.S. Cl. CPC H04B 7/0456; H04L 27/2636

(57) ABSTRACT

A precoding matrix indication method, performed by a terminal. The precoding matrix indication method includes: receiving configuration information of a distance from the terminal to a network device, which is sent by the network device; determining indication information of a precoding matrix at least based on the configuration information of the distance; and sending the indication information of the precoding matrix to the network device.

### CROSS-REFERENCE TO RELATED APPLICATION

This application is the U.S. national phase application of International Application No. PCT/CN2023/088211, filed on Apr. 13, 2023, the disclosure of which is incorporated herein by reference in its entirety.

### TECHNICAL FIELD

The present disclosure relates to the field of communication technologies, and in particular to a precoding matrix indication method, an indication information reception method, a precoding matrix indication apparatus, an indication information reception apparatus, a communication system, a communication device, and a computer-readable storage medium.

### BACKGROUND

During communication with a terminal, a network device may perform a precoding operation to ensure good performance gain. However, there are some issues with the current technologies for precoding.

### SUMMARY

Examples of the present disclosure provide a precoding matrix indication method, an indication information reception method, a precoding matrix indication apparatus, an indication information reception apparatus, a communication system, a communication device, and a computer-readable storage medium to solve technical problems in related technologies.

According to a first aspect of the examples of the present disclosure, a precoding matrix indication method is provided, which is performed by a terminal. The method includes: receiving configuration information of a distance from the terminal to a network device, which is sent by the network device; determining indication information of a precoding matrix at least based on the configuration information of the distance; and sending the indication information of the precoding matrix to the network device.

According to a second aspect of the examples of the present disclosure, an indication information reception method is provided, which is performed by a network device. The method includes: sending, to a terminal, configuration information of a distance from the terminal to the network device; and receiving indication information of a precoding matrix determined by the terminal at least based on the configuration information of the distance.

According to a third aspect of the examples of the present disclosure, a communication device is provided, including: one or more processors; and one or more memories for storing a computer program; wherein the computer program, when executed by the one or more processors, implements: receiving configuration information of a distance from a terminal to a network device, which is sent by the network device; determining indication information of a precoding matrix at least based on the configuration information of the distance; and sending the indication information of the precoding matrix to the network device.

### BRIEF DESCRIPTION OF THE DRAWINGS

The drawings related to the description of examples will be briefly introduced to explain the technical solutions provided by the examples of the present disclosure more clearly. It is obvious that the drawings in the following description illustrate only some examples of the present disclosure, and based on these drawings, those of ordinary skill in the art may obtain other drawings without creative work.

FIG. 1 illustrates a schematic diagram of an application scenario according to an example of the present disclosure.

FIG. 2 illustrates a schematic flowchart of a precoding matrix indication method according to an example of the present disclosure.

FIG. 3 illustrates a schematic flowchart of another precoding matrix indication method according to an example of the present disclosure.

FIG. 4 illustrates a schematic flowchart of another precoding matrix indication method according to an example of the present disclosure.

FIG. 5 illustrates a schematic flowchart of another precoding matrix indication method according to an example of the present disclosure.

FIG. 6 illustrates a schematic flowchart of an indication information reception method according to an example of the present disclosure.

FIG. 7 illustrates a schematic block diagram of a precoding matrix indication apparatus according to an example of the present disclosure.

FIG. 8 illustrates a schematic block diagram of an indication information reception apparatus according to an example of the present disclosure.

FIG. 9 illustrates a schematic block diagram of a device for receiving indication information according to an example of the present disclosure.

FIG. 10 illustrates a schematic block diagram of a device for indicating a precoding matrix according to an example of the present disclosure.

### DETAILED DESCRIPTION OF THE EMBODIMENTS

The implementations or examples of the present disclosure are not exhaustive and are merely illustrations of some implementations or examples, and are not intended to limit the protection scope of the present disclosure. Provided there is no conflict, each step in a certain implementation or example may be implemented as an independent example, and various steps may be arbitrarily combined. For example, a solution after removing some steps from a certain implementation or example may also be implemented as an independent example. The order of various steps in a certain implementation or example may be arbitrarily exchanged. In addition, the alternative or additional schemes or instances in a certain implementation or example may be arbitrarily combined. In addition, various implementations or examples may be arbitrarily combined. For example, some or all steps of different implementations or examples may be arbitrarily combined, and a certain implementation or example may be arbitrarily combined with the alternative or additional schemes or instances of another implementation or example.

In some implementations or examples, the terms “in response to,” “in the case that,” “at the time of,” “when,” “supposing that,” “if,” etc., in the present disclosure may be replaced with each other.

In some implementations or examples, the description of the present disclosure, such as “A or B,” “A and/or B,” “at least one of A or B,” “A in one case, and B in another case,” “A in response to one case, B in response to another case,” etc., may include at least one of the following technical solutions as appropriate: performing A independently of B, that is, A in some implementations or examples; performing B independently of A, that is, B in some implementations or examples; selectively performing A or B, that is, A or B that is selected and performed in some implementations or examples; performing both A and B, that is, A and B in some implementations or examples.

In some implementations or examples, “including A,” “comprising A,” “used to indicate A,” and “carrying A” in the present disclosure may be interpreted as directly carrying A or indirectly indicating A.

In addition, each element, each row, or each column in a table involved in the present disclosure may be implemented as an independent example, and a combination of any elements, any rows, and any columns may also be implemented as an independent example.

According to the examples of the present disclosure, a network device may send configuration information of a distance from a terminal to the network device to the terminal, so that the terminal, when determining indication information of a precoding matrix, may determine the indication information of the precoding matrix at least based on the configuration information of the distance, thereby accurately determining the indication information of the precoding matrix in a near-field communication scenario.

The terminal then sends the indication information of the precoding matrix to the network device, and the network device may determine the precoding matrix according to the indication information of the precoding matrix and perform a precoding operation according to the determined precoding matrix. This precoding result may also be well-suited for the near field communication scenario.

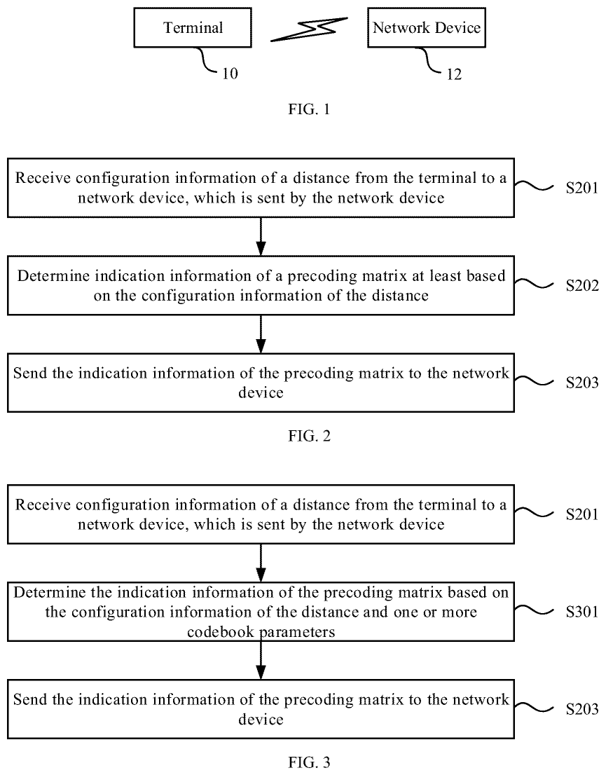

FIG. 1 illustrates a schematic diagram of an application scenario according to an example of the present disclosure.

As illustrated in FIG. 1, the examples of the present disclosure may be applied to a scenario where a terminal 10 communicates with a network device 12, but are not limited to this scenario. The various entities illustrated in FIG. 1 are illustrations. The implementations or examples of the present disclosure may include all or part of the entities in FIG. 1, or may include entities other than those in FIG. 1. The number of the various entities is arbitrary and is not limited to FIG. 1. The various connection relationships of FIG. 1 are illustrations. It may be connected or disconnected between any entities. The connection may be made in any way, whether direct or indirect, and whether wired or wireless.

In an example, the terminal 10 includes, but is not limited to, a mobile phone, a tablet computer, a wearable device, a sensor, an Internet of Things device, and another communication device. The terminal 10 may communicate with the network device 12. The network device 12 includes, but is not limited to, a network device in a fourth generation (4G), fifth generation (5G), sixth generation (6G), and another communication system, such as a base station and a core network.

In an example, the network device 12 may also include at least one of the following: a network control repeater, a massive antenna array, or a reconfigurable intelligent surface (RIS).

In an example, the terminal 10 may determine indication information of a precoding matrix and send the indication information to the network device 12, so that the network device 12 determines the precoding matrix and then performs a precoding operation according to the precoding matrix.

In an example, the precoding may include codebook-based precoding and non-codebook precoding. The present disclosure mainly takes the codebook-based precoding for illustration.

In an example, the terminal 10 may measure a downlink channel to obtain channel information (e.g., a channel matrix), then select the precoding matrix having a highest matching degree with the channel information from the codebook in accordance with a predetermined optimization criterion, and then send the indication information of the selected precoding matrix to the network device. For example, the codebook may include a discrete Fourier transform (DFT) codebook, and the indication information may include a DFT codebook index.

The precoding technology has been designed for a far-field communication scenario because the scenario of the communication between the terminal 10 and the network device 12, where the distance between the terminal 10 and the network device 12 is relatively far and the size of the terminal 10 and the network device 12 is relatively small, is suitable for the far-field communication scenario. However, with the development of communication technologies, the size of the network device 12 has increased. For example, the network device 12 is the massive antenna array, the RIS, etc., which makes the communication scenario tend to be a near-field communication scenario. The precoding still performed in accordance with the processing scheme of the far-field communication scenario is difficult to accurately adapt to the near-field communication scenario.

FIG. 2 illustrates a schematic flowchart of a precoding matrix indication method according to an example of the present disclosure. The precoding matrix indication method illustrated in this example may be performed by a terminal.

As illustrated in FIG. 2, the precoding matrix indication method may include the following steps, S201-S203.

At step S201, configuration information of a distance from the terminal to a network device, which is sent by the network device, is received.

At step S202, indication information of a precoding matrix is determined at least based on the configuration information of the distance.

At step S203, the indication information of the precoding matrix is sent to the network device.

In an example, since the communication between the terminal and the network device belongs to a near field communication scenario, the terminal is to consider the distance between the terminal and the network device when determining the indication information of the precoding matrix.

Therefore, in the example of the present disclosure, the network device may send the configuration information of the distance from the terminal to the network device to the terminal, so that the terminal, when determining the indication information of the precoding matrix, may determine the indication information of the precoding matrix at least based on the configuration information of the distance, thereby accurately determining the indication information of the precoding matrix in the near-field communication scenario.

The terminal then sends the indication information of the precoding matrix to the network device, and the network device may determine the precoding matrix according to the indication information of the precoding matrix and perform a precoding operation according to the determined precoding matrix. This precoding result may also be well-suited for the near field communication scenario.

It is to be noted that the network device may determine the precoding matrix, according to or not according to the indication information of the precoding matrix sent by the terminal. The way of determining the precoding matrix may be independently selected by the network device.

In an example, the configuration information of the distance includes at least one of the following: distance interval information, or distance quantization step information. Particularly, the distance interval information may represent an interval of the distance from the terminal to the network device, for example, it may be 0 to 100 meters. The distance quantization step information may be used for quantizing the distance interval.

In an example, the distance interval information includes at least one of the following: an identifier corresponding to the distance interval, a starting point of the distance interval, an ending point of the distance interval, or a length of the distance interval.

In an example, the distance interval information may include the identifier corresponding to the distance interval, and the terminal may determine the distance interval corresponding to the identifier according to an association relationship between identifiers and distance intervals. For example, Identifier 1 corresponds to a distance interval of 0 to 100 meters, and Identifier 2 corresponds to a distance interval of 0 to 200 meters. When the distance interval information received by the terminal is Identifier 1, the terminal may determine the distance interval as being 0 to 100 meters.

In an example, the distance interval information may include the starting point and the ending point of the distance interval, and the terminal may determine the distance interval according to the starting point and the ending point. For example, if the starting point is 0 and the ending point is 100 meters, the terminal may determine the distance interval as being 0 to 100 meters.

In an example, the distance interval information may include the starting point of the distance interval and the length of the distance interval, and the terminal may determine the distance interval according to the starting point and the length. For example, if the starting point is 0 and the length is 100 meters, the terminal may determine the distance interval as being 0 to 100 meters.

In an example, the distance quantization step includes at least one of the following: a uniform quantization step, or a non-uniform quantization step.

In an example, the uniform quantization step includes one step for uniformly quantizing the distance interval.

Taking the distance interval being 0 to 100 meters as an example, and if the uniform quantization step is 10 meters for example, a quantization result may include a plurality of reference distances: 0 meters, 10 meters, 20 meters, 30 meters, 40 meters, 50 meters, 60 meters, 70 meters, 80 meters, 90 meters, and 100 meters.

In an example, the non-uniform quantization step includes an initial quantization step and one or more quantization step parameters. The non-uniform quantization step is used for performing a non-uniform quantization on the distance interval. Particularly, the n-th quantization step among a plurality of quantization steps, stepₙ=f(n), where n is an integer, and f(x) is a function determined according to the one or more quantization step parameters.

For example, the f(x) is a polynomial, the quantization step parameters are k₁ and k₂, and the terminal may determine: f(x)=step₀+k₁ (stepₓ−step₀)+k₂ (stepₓ−step₀)², where the step₀ represents the initial quantization step.

Substituting x=n, it may be determined that stepₙ=step₀+k₁ (stepₙ−step₀)+k₂ (stepₙ−step₀)². Consequently, n non-uniform quantization steps may be determined. In this way, the non-uniform quantization on the distance interval may be performed using these n non-uniform quantization steps.

It is to be noted that the one or more quantization step parameters are not limited to those described in this example, and f(x) is not limited to the above function form. For example, when n=4, four non-uniform quantization steps are determined to be 10 meters, 20 meters, 30 meters, and 40 meters. By quantizing the distance interval of 0 to 100 meters using these four non-uniform quantization steps, the obtained quantization result may include a plurality of reference distances: 0 meters, 10 meters, 30 meters, 60 meters, and 100 meters.

In an example, the indication information of the precoding matrix includes at least one of the following: an index of the precoding matrix, reference distance information corresponding to the precoding matrix, or reference angle information corresponding to the precoding matrix.

For example, the network device and the terminal may pre-store a correspondence between indication information of precoding matrices and the precoding matrices.

When the indication information of the precoding matrix includes the index of the precoding matrix, the terminal sends the index of the precoding matrix to the network device, and the network device may determine the precoding matrix according to a correspondence between the indexes of precoding matrices and the precoding matrices.

When the indication information of the precoding matrix includes the reference distance information corresponding to the precoding matrix, the terminal sends the reference distance information corresponding to the precoding matrix to the network device, and the network device may determine the precoding matrix according to a correspondence between reference distance information corresponding to precoding matrices and the precoding matrices.

When the indication information of the precoding matrix includes the reference angle information corresponding to the precoding matrix, the terminal sends the reference angle information corresponding to the precoding matrix to the network device, and the network device may determine the precoding matrix according to a correspondence between reference angle information corresponding to precoding matrices and the precoding matrices.

FIG. 3 illustrates a schematic flowchart of another precoding matrix indication method according to an example of the present disclosure. The method of this example may be performed by a terminal. As illustrated in FIG. 3, determining indication information of a precoding matrix at least based on configuration information of a distance includes step S301, in addition to the previously described steps S201 and S203.

At step S301, the indication information of the precoding matrix is determined based on the configuration information of the distance and one or more codebook parameters.

It is to be noted that the example illustrated in FIG. 3 may be implemented independently or in combination with at least one other example of the present disclosure. The specific selection may be made as needed, and the present disclosure does not limit it.

In an example, the terminal may determine the indication information of the precoding matrix based not only on the configuration information of the distance, but also on the one or more codebook parameters, so as to more accurately determine the indication information of the precoding matrix. Particularly, the terminal may receive the one or more codebook parameters and the configuration information of the distance through the same signaling. Alternatively, the terminal may receive the one or more codebook parameters and the configuration information of the distance separately through different signaling, for example, receiving the signaling carrying the one or more codebook parameters first, or receiving the signaling carrying the configuration information of the distance first. The signaling includes, but is not limited to, radio resource control (RRC) signaling.

In an example, the one or more codebook parameters include at least one of the following: one or more parameters related to a 2-dimension (2D) DFT codebook, an angle range and an angle quantization step with respect to an antenna array of the network device in a first dimension, or an angle range and an angle quantization step with respect to the antenna array of the network device in a second dimension. For example, the first dimension may be a horizontal dimension, and the second dimension may be a vertical dimension. The angle quantization step is used for quantizing the angle range, and the quantization scheme may include at least one of a uniform quantization or a non-uniform quantization.

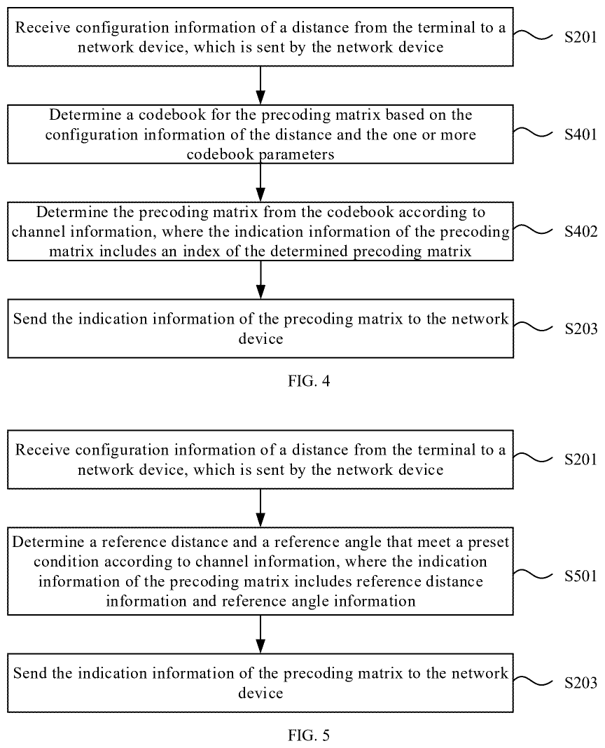

FIG. 4 illustrates a schematic flowchart of another precoding matrix indication method according to an example of the present disclosure. The method of this example may be performed by a terminal. As illustrated in FIG. 4, determining indication information of a precoding matrix based on configuration information of a distance and one or more codebook parameters includes steps S401 and S402, along with previously described steps S201 and S203.

At step S401, a codebook for the precoding matrix is determined based on the configuration information of the distance and the one or more codebook parameters.

At step S402, the precoding matrix is determined from the codebook according to channel information. The indication information of the precoding matrix includes an index of the determined precoding matrix.

It is to be noted that the example illustrated in FIG. 4 may be implemented independently or in combination with at least one other example of the present disclosure. The specific selection may be made as needed, and the present disclosure does not limit it.

In an example, when the indication information of the precoding matrix includes the index of the determined precoding matrix, the terminal may first determine the codebook for the precoding matrix based on the configuration information of the distance and the one or more codebook parameters, and then determine the index of the precoding matrix from the codebook, and send it to the network device as the indication information of the precoding matrix.

In an example, a distance quantization result may include a plurality of reference distances, and an angle quantization result may include a plurality of reference angles. For example, one of the plurality of reference angles is θ. Supposing θ₁=0, it may further determine θ₁, θ₂, θ₃, θ₄ to θₙ based on θ₁, where n may be determined based on the number of antennas in an antenna array of the network device. Taking a reference distance R among the plurality of quantized reference distances as an example, a codeword bₙ in a codebook B may be obtained according to the reference distance and the reference angles. For example, if the number of antennas in the antenna array is 5, n=5, and bₙ may be determined in accordance with the following formula:

$${b}_{n} = [ {e}^{j \frac{2 π {R}^{′}}{sin {θ}_{1} λ}} , {e}^{j \frac{2 π {R}^{′}}{sin {θ}_{2} λ}} , {e}^{j \frac{2 π {R}^{′}}{sin {θ}_{3} λ}} , {e}^{j \frac{2 π {R}^{′}}{sin {θ}_{4} λ}} , {e}^{j \frac{2 π {R}^{′}}{sin {θ}_{5} λ}} ]$$

Particularly, bₙ∈B, R′=R sin θ₁,

$${θ}_{n} = arctan \frac{R sin {θ}_{1}}{R cos {θ}_{1} + ( n - 1 ) d} ,$$

and d is the distance between the antennas among the plurality of antennas included in the network device.

The codeword may represent the precoding matrix. The terminal may determine the channel information (that may include a channel matrix) by measuring a downlink channel, such as measuring a common pilot, and then determine the precoding matrix from the codebook according to the channel information. For example, the precoding matrix with the highest matching degree with the channel information may be selected from the codebook in accordance with a predetermined optimization criterion. The index of the selected precoding matrix is sent to the network device.

FIG. 5 illustrates a schematic flowchart of another precoding matrix indication method according to an example of the present disclosure. The method of this example may be performed by a terminal. As illustrated in FIG. 5, determining indication information of a precoding matrix based on configuration information of a distance and one or more codebook parameters includes step S501, along with previously described steps S201 and S203.

At step S501, a reference distance and a reference angle that meet a preset condition are determined according to channel information. Particularly, the indication information of the precoding matrix includes reference distance information and reference angle information.

It is to be noted that the example illustrated in FIG. 5 may be implemented independently or in combination with at least one other example of the present disclosure. The specific selection may be made as needed, and the present disclosure does not limit it.

In an example, when the indication information of the precoding matrix includes the reference distance information and the reference angle information, the terminal may determine the reference distance and the reference angle that meet the preset condition according to the channel information, and send the information on the reference distance and the reference angle that meet the preset condition as the indication information of the precoding matrix to the network device.

In an example, determining the indication information of the precoding matrix based on the configuration information of the distance and the one or more codebook parameters further includes: determining at least one reference distance and at least one reference angle corresponding to the precoding matrix based on the configuration information of the distance and the one or more codebook parameters. The reference distance that meets the preset condition is a reference distance with the highest matching degree with the channel information among the at least one reference distance, and/or the reference angle that meets the preset condition is a reference angle with the highest matching degree with the channel information among the at least one reference angle.

Particularly, the terminal may determine the reference distance with the highest matching degree and the reference angle with the highest matching degree, based on or not based on a positioning capability.

For example, the terminal may determine a coordinate system based on distances and angles, and determine the coordinates corresponding to each reference distance and each reference angle. Then, the terminal may determine its own position based on the positioning capability, and determine the reference distance and the reference angle corresponding to the coordinates closest to the position as the reference distance with the highest matching degree and the reference angle with the highest matching degree.

For example, the terminal may estimate a distance from the terminal to the network device based on a path loss, and determine a distance closest to the estimated distance among the plurality of reference distances as the reference distance with the highest matching degree. The terminal may determine the channel information (that may include a channel matrix) by measuring a downlink channel, such as measuring a common pilot, and then determine the reference angle with the highest matching degree with the channel information among the plurality of reference angles.

The network device may pre-store an association relationship between precoding matrices, pieces of reference distance information, and pieces of reference angle information, then may determine the precoding matrix corresponding to the reference distance with the highest matching degree and the reference angle with the highest matching degree in accordance with the association relationship, and perform a precoding operation according to the precoding matrix.

FIG. 6 illustrates a schematic flowchart of an indication information reception method according to an example of the present disclosure. The indication information reception method illustrated in this example may be performed by a network device. The network device may communicate with a terminal. The network device includes, but is not limited to, a base station in a communication system, such as a 4G base station, a 5G base station, and a 6G base station. The network device may also include at least one of the following: a network control repeater, a massive antenna array, or an RIS. The terminal includes, but is not limited to, a mobile phone, a tablet computer, a wearable device, a sensor, an Internet of Things device, and another communication device.

As illustrated in FIG. 6, the indication information reception method may include the following steps, S601 and S602.

At step S601, configuration information of a distance from the terminal to the network device is sent to the terminal.

At step S602, indication information of a precoding matrix determined by the terminal, at least based on the configuration information of the distance, is received.

In an example, since the communication between the terminal and the network device belongs to a near field communication scenario, the terminal is to consider the distance between the terminal and the network device when determining the indication information of the precoding matrix.

Therefore, in the example of the present disclosure, the network device may send the configuration information of the distance from the terminal to the network device to the terminal, so that the terminal, when determining the indication information of the precoding matrix, may determine the indication information of the precoding matrix at least based on the configuration information of the distance, thereby accurately determining the indication information of the precoding matrix in the near-field communication scenario.

The terminal then sends the indication information of the precoding matrix to the network device, and the network device may determine the precoding matrix according to the indication information of the precoding matrix and perform a precoding operation according to the determined precoding matrix. This precoding result may also be well-suited for the near field communication scenario.

It is to be noted that the network device may determine the precoding matrix, according to or not according to the indication information of the precoding matrix sent by the terminal. The way of determining the precoding matrix may be independently selected by the network device.

In an example, the configuration information of the distance includes at least one of the following: distance interval information, or distance quantization step information. Particularly, the distance interval information may represent an interval of the distance from the terminal to the network device, for example, it may be 0 to 100 meters. The distance quantization step information may be used for quantizing the distance interval.

In an example, the distance interval information includes at least one of the following: an identifier corresponding to the distance interval, a starting point of the distance interval, an ending point of the distance interval, or a length of the distance interval.

In an example, the distance interval information may include the identifier corresponding to the distance interval, and the terminal may determine the distance interval corresponding to the identifier according to an association relationship between identifiers and distance intervals. For example, Identifier 1 corresponds to a distance interval of 0 to 100 meters, and Identifier 2 corresponds to a distance interval of 0 to 200 meters. When the distance interval information is Identifier 1, it may indicate to the terminal that the distance interval is 0 to 100 meters.

In an example, the distance interval information may include the starting point and the ending point of the distance interval, and the terminal may determine the distance interval according to the starting point and the ending point. For example, if the starting point is 0 and the ending point is 100 meters, it may indicate to the terminal that the distance interval is 0 to 100 meters.

In an example, the distance interval information may include the starting point of the distance interval and the length of the distance interval, and the terminal may determine the distance interval according to the starting point and the length. For example, if the starting point is 0 and the length is 100 meters, it may indicate to the terminal that the distance interval is 0 to 100 meters.

In an example, the distance quantization step includes at least one of the following: a uniform quantization step, or a non-uniform quantization step.

In an example, the uniform quantization step includes one step for uniformly quantizing the distance interval.

Taking the distance interval being 0 to 100 meters as an example, and if the uniform quantization step is 10 meters for example, a quantization result may include a plurality of reference distances: 0 meters, 10 meters, 20 meters, 30 meters, 40 meters, 50 meters, 60 meters, 70 meters, 80 meters, 90 meters, and 100 meters.

In an example, the non-uniform quantization step includes an initial quantization step and one or more quantization step parameters. The non-uniform quantization step is used for performing a non-uniform quantization on the distance interval. The n-th quantization step among a plurality of quantization steps, stepₙ=f(n), where n is an integer, and f(x) is a function determined according to the one or more quantization step parameters.

For example, the f(x) is a polynomial, the quantization step parameters are k₁ and k₂, and it may indicate to the terminal that: f(x)=step₀+k₁ (stepₓ−step₀)+k₂ (stepₓ−step₀)², where the step₀ represents the initial quantization step.

Substituting x=n, it may be determined that stepₙ=step₀+k₁ (stepₙ−step₀)+k₂ (stepₙ−step₀)². Consequently, n non-uniform quantization steps may be determined. In this way, the non-uniform quantization on the distance interval may be performed using these n non-uniform quantization steps.

It is to be noted that the one or more quantization step parameters are not limited to those described in this example, and the f(x) is not limited to the above function form. For example, when n=4, four non-uniform quantization steps are determined to be 10 meters, 20 meters, 30 meters, and 40 meters. By quantizing the distance interval of 0 to 100 meters using these four non-uniform quantization steps, the obtained quantization result may include a plurality of reference distances: 0 meters, 10 meters, 30 meters, 60 meters, and 100 meters.

In an example, the indication information of the precoding matrix includes at least one of the following: an index of the precoding matrix, reference distance information corresponding to the precoding matrix, or reference angle information corresponding to the precoding matrix.

For example, the network device and the terminal may pre-store a correspondence between indication information of precoding matrices and the precoding matrices.

When the indication information of the precoding matrix includes the index of the precoding matrix, the terminal sends the index of the precoding matrix to the network device, and the network device may determine the precoding matrix according to a correspondence between the indexes of precoding matrices and the precoding matrices.

When the indication information of the precoding matrix includes the reference distance information corresponding to the precoding matrix, the terminal sends the reference distance information corresponding to the precoding matrix to the network device, and the network device may determine the precoding matrix according to a correspondence between reference distance information corresponding to precoding matrices and the precoding matrices.

When the indication information of the precoding matrix includes the reference angle information corresponding to the precoding matrix, the terminal sends the reference angle information corresponding to the precoding matrix to the network device, and the network device may determine the precoding matrix according to a correspondence between reference angle information corresponding to precoding matrices and the precoding matrices.

In an example, the indication information reception method further includes: sending the one or more codebook parameters to the terminal. By sending the codebook information to the terminal, the terminal may determine the indication information of the precoding matrix based not only on the configuration information of the distance, but also on the one or more codebook parameters, so as to more accurately determine the indication information of the precoding matrix.

Particularly, the network device may send the one or more codebook parameters and the configuration information of the distance to the terminal through the same signaling. Alternatively, the network device may send the one or more codebook parameters and the configuration information of the distance to the terminal separately through different signaling, for example, sending the signaling carrying the one or more codebook parameters first, or sending the signaling carrying the configuration information of the distance first. The signaling includes, but is not limited to, RRC signaling.

In an example, the one or more codebook parameters include at least one of the following: one or more parameters related to a 2-dimension (2D) DFT codebook, an angle range and an angle quantization step with respect to an antenna array of the network device in a first dimension, or an angle range and an angle quantization step with respect to the antenna array of the network device in a second dimension. For example, the first dimension may be a horizontal dimension, and the second dimension may be a vertical dimension. The angle quantization step is used for quantizing the angle range, and the quantization scheme may include at least one of the uniform quantization or the non-uniform quantization.

In an example, the configuration information of the distance and the one or more codebook parameters are used for determining a codebook for the precoding matrix.

In an example, when the indication information of the precoding matrix includes the index of the determined precoding matrix, the terminal may first determine the codebook for the precoding matrix based on the configuration information of the distance and the one or more codebook parameters, and then determine the index of the precoding matrix from the codebook, and send it to the network device as the indication information of the precoding matrix.

In an example, a distance quantization result may include a plurality of reference distances, and an angle quantization result may include a plurality of reference angles. For example, one of the plurality of reference angles is θ. Supposing θ₁=θ, it may further determine θ₂, θ₃, θ₄ to θₙ based on θ₁, where n may be determined based on the number of antennas in the antenna array of the network device. Taking a reference distance R among the plurality of quantized reference distances as an example, a codeword bₙ in a codebook B may be obtained according to the reference distance and the reference angles. For example, if the number of antennas in the antenna array is 5, n=5, and bₙ may be determined in accordance with the following formula:

$${b}_{n} = [ {e}^{j \frac{2 π {R}^{′}}{sin {θ}_{1} λ}} , {e}^{j \frac{2 π {R}^{′}}{sin {θ}_{2} λ}} , {e}^{j \frac{2 π {R}^{′}}{sin {θ}_{3} λ}} , {e}^{j \frac{2 π {R}^{′}}{sin {θ}_{4} λ}} , {e}^{j \frac{2 π {R}^{′}}{sin {θ}_{5} λ}} ]$$

Particularly, bₙ∈B, R′=R sin θ₁,

$${θ}_{n} = arctan \frac{R sin {θ}_{1}}{R cos {θ}_{1} + ( n - 1 ) d} ,$$

and d is the distance, between the antennas among the plurality of antennas included in the network device.

The codeword may represent the precoding matrix. The terminal may determine the channel information (that may include a channel matrix) by measuring a downlink channel, such as measuring a common pilot, and then determine the precoding matrix from the codebook according to the channel information. For example, the precoding matrix with the highest matching degree with the channel information may be selected from the codebook in accordance with a predetermined optimization criterion. The index of the selected precoding matrix is sent to the network device.

In an example, the configuration information of the distance and the one or more codebook parameters are used for determining at least one reference distance and at least one reference angle corresponding to the precoding matrix.

In an example, when the indication information of the precoding matrix includes the reference distance information and the reference angle information, the terminal may determine the reference distance and the reference angle that meet the preset condition according to the channel information, and send the information on the reference distance and the reference angle that meet the preset condition as the indication information of the precoding matrix to the network device.

In an example, determining the indication information of the precoding matrix based on the configuration information of the distance and the one or more codebook parameters further includes: determining at least one reference distance and at least one reference angle corresponding to the precoding matrix based on the configuration information of the distance and the one or more codebook parameters. The reference distance that meets the preset condition is a reference distance with the highest matching degree with the channel information among the at least one reference distance, and/or the reference angle that meets the preset condition is a reference angle with the highest matching degree with the channel information among the at least one reference angle.

Particularly, the terminal may determine the reference distance with the highest matching degree and the reference angle with the highest matching degree, based on or not based on a positioning capability.

For example, the terminal may determine a coordinate system based on distances and angles, and determine the coordinates corresponding to each reference distance and each reference angle. Then, the terminal may determine its own position based on the positioning capability, and determine the reference distance and the reference angle corresponding to the coordinates closest to the position as the reference distance with the highest matching degree and the reference angle with the highest matching degree.

For example, the terminal may estimate a distance from the terminal to the network device based on a path loss, and determine a distance closest to the estimated distance among the plurality of reference distances as the reference distance with the highest matching degree. The terminal may determine the channel information (that may include the channel matrix) by measuring the downlink channel, such as measuring the common pilot, and then determine the reference angle with the highest matching degree with the channel information among the plurality of reference angles.

The network device may pre-store an association relationship between precoding matrices, pieces of reference distance information, and pieces of reference angle information, then may determine the precoding matrix corresponding to the reference distance with the highest matching degree and the reference angle with the highest matching degree in accordance with the association relationship, and perform a precoding operation according to the precoding matrix.

The examples of the present disclosure also provide a precoding matrix indication method, which may be performed by a communication system including a terminal and a network device.

Particularly, the terminal is configured to receive configuration information of a distance from the terminal to the network device, which is sent by the network device; determine indication information of a precoding matrix at least based on the configuration information of the distance; and send the indication information of the precoding matrix to the network device.

The network device is configured to send the configuration information of the distance from the terminal to the network device to the terminal, and receive the indication information of the precoding matrix determined by the terminal at least based on the configuration information of the distance.

It is to be noted that other contents involved in this example may refer to the description of the relevant contents in the previous examples, which are not repeated here.

Corresponding to the examples of the precoding matrix indication method and the indication information reception method, the present disclosure also provides examples of a precoding matrix indication apparatus and an indication information reception apparatus.

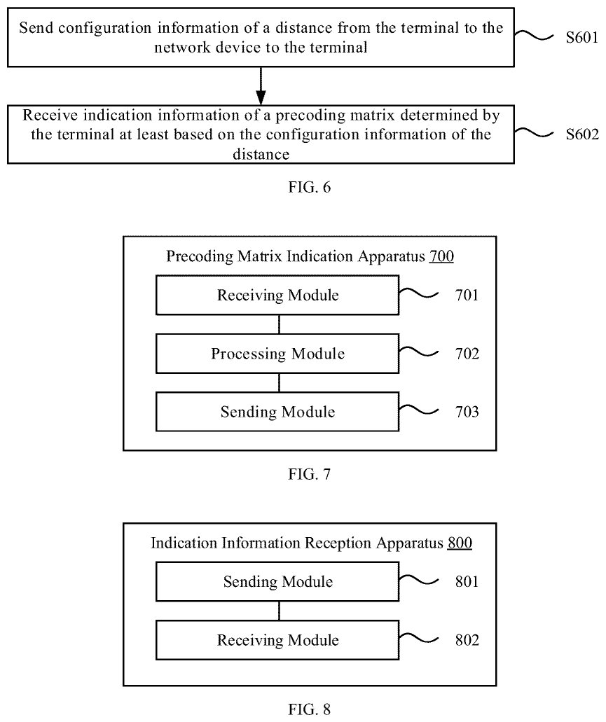

FIG. 7 illustrates a schematic block diagram of a precoding matrix indication apparatus according to an example of the present disclosure. The apparatus may be configured in a terminal. As illustrated in FIG. 7, the precoding matrix indication apparatus 700 includes a receiving module 701, a processing module 702, and a sending module 703.

The receiving module 701 is configured to receive configuration information of a distance from the terminal to a network device, which is sent by the network device.

The processing module 702 is configured to determine indication information of a precoding matrix at least based on the configuration information of the distance.

The sending module 703 is configured to send the indication information of the precoding matrix to the network device.

In an example, the configuration information of the distance includes at least one of the following: distance interval information, or distance quantization step information.

In an example, the distance interval information includes at least one of the following: an identifier corresponding to a distance interval, a starting point of the distance interval, an ending point of the distance interval, or a length of the distance interval.

In an example, the distance quantization step includes at least one of the following: a uniform quantization step, or a non-uniform quantization step.

In an example, the uniform quantization step includes one step for uniformly quantizing the distance interval; and/or the non-uniform quantization step includes an initial quantization step and one or more quantization step parameters, and is used for performing a non-uniform quantization on the distance interval. An n-th quantization step among a plurality of quantization steps, stepₙ=f(n), with n being an integer and f(x) being a function determined according to the one or more quantization step parameters.

In an example, the indication information of the precoding matrix includes at least one of the following: an index of the precoding matrix, reference distance information corresponding to the precoding matrix, or reference angle information corresponding to the precoding matrix.

In an example, the processing module is configured to determine the indication information of the precoding matrix based on the configuration information of the distance and one or more codebook parameters.

In an example, the processing module is configured to determine a codebook for the precoding matrix based on the configuration information of the distance and the one or more codebook parameters; and determine the precoding matrix from the codebook according to channel information. The indication information of the precoding matrix includes an index of the determined precoding matrix.

In an example, the processing module is configured to determine, according to channel information, a reference distance and a reference angle that meet a preset condition. The indication information of the precoding matrix includes the reference distance information and the reference angle information.

In an example, the processing module is further configured to determine at least one reference distance and at least one reference angle corresponding to the precoding matrix based on the configuration information of the distance and the one or more codebook parameters. The reference distance that meets the preset condition is a reference distance with a highest matching degree with the channel information among the at least one reference distance, and/or the reference angle that meets the preset condition is a reference angle with a highest matching degree with the channel information among the at least one reference distance.

In an example, the one or more codebook parameters include at least one of the following: one or more parameters related to a 2D DFT codebook, an angle range and an angle quantization step with respect to an antenna array of the network device in a first dimension, or an angle range and an angle quantization step with respect to the antenna array of the network device in a second dimension.

In an example, the network device includes at least one of the following: a network control repeater, a massive antenna array, or an RIS.

FIG. 8 illustrates a schematic block diagram of an indication information reception apparatus according to an example of the present disclosure. The apparatus is configured in a network device. As illustrated in FIG. 8, the indication information reception apparatus 800 includes a sending module 801 and a receiving module 802.

The sending module 801 is configured to send, to the terminal, configuration information of a distance from a terminal to the network device.

The receiving module 802 is configured to receive indication information of a precoding matrix determined by the terminal, at least based on the configuration information of the distance.

In an example, the configuration information of the distance includes at least one of the following: distance interval information, or distance quantization step information.

In an example, the distance interval information includes at least one of the following: an identifier corresponding to a distance interval, a starting point of the distance interval, an ending point of the distance interval, or a length of the distance interval.

In an example, the distance quantization step includes at least one of the following: a uniform quantization step, or a non-uniform quantization step.

In an example, the uniform quantization step includes one step for uniformly quantizing the distance interval; and/or the non-uniform quantization step includes an initial quantization step and one or more quantization step parameters, and is used for performing a non-uniform quantization on the distance interval. An n-th quantization step among a plurality of quantization steps, stepₙ=f(n), with n being an integer and f(x) being a function determined according to the one or more quantization step parameters.

In an example, the indication information of the precoding matrix includes at least one of the following: an index of the precoding matrix, reference distance information corresponding to the precoding matrix, or reference angle information corresponding to the precoding matrix.

In an example, the sending module is further configured to send one or more codebook parameters to the terminal.

In an example, the configuration information of the distance and the one or more codebook parameters are used for determining a codebook for the precoding matrix.

In an example, the configuration information of the distance and the one or more codebook parameters are used for determining at least one reference distance and at least one reference angle corresponding to the precoding matrix.

In an example, the one or more codebook parameters include at least one of the following: one or more parameters related to a 2D DFT codebook, an angle range and an angle quantization step with respect to an antenna array of the network device in a first dimension, or an angle range and an angle quantization step with respect to the antenna array of the network device in a second dimension.

In an example, the network device includes at least one of the following: a network control repeater, a massive antenna array, or an RIS.

Since the apparatus examples essentially correspond to the method examples, reference may be made to the description of related parts of the method examples. The apparatus examples described above are merely illustrative, in which the modules described as separate components may or may not be physically separated, and the components displayed as modules may or may not be physical modules, that is, may be located in one place or distributed to multiple network modules. Some or all of the modules may be selected according to actual needs to achieve the objectives of the implementations of the examples. It can be understood and implemented by those of ordinary skill in the art without any creative effort.

The examples of the present disclosure also provide a communication system, including a terminal and a network device. The terminal is configured to implement the precoding matrix indication method described in any one of the foregoing examples, and the network device is configured to implement the indication information reception method described in any one of the foregoing examples.

The examples of the present disclosure also provide a communication device, including one or more processors and one or more memories for storing a computer program. The computer program, when executed by the one or more processors, implements the precoding matrix indication method described in any one of the foregoing examples.

The examples of the present disclosure also provide a communication device, including one or more processors and one or more memories for storing a computer program. The computer program, when executed by the one or more processors, implements the indication information reception method described in any one of the foregoing examples.

The examples of the present disclosure also provide a computer-readable storage medium for storing a computer program. The computer program, when executed by one or more processors, implements the precoding matrix indication method described in any one of the foregoing examples.

The examples of the present disclosure also provide a computer-readable storage medium for storing a computer program. The computer program, when executed by one or more processors, implements the indication information reception method described in any one of the foregoing examples.

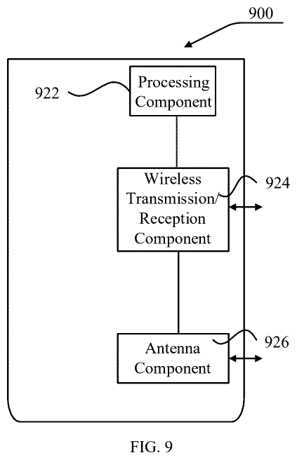

As illustrated in FIG. 9, FIG. 9 illustrates a schematic block diagram of a device 900 for receiving indication information according to an example of the present disclosure. The device 900 may be a base station. Referring to FIG. 9, the device 900 includes a processing component 922, a wireless transmission/reception component 924, an antenna component 926, and a signal processing part peculiar to a wireless interface. The processing component 922 may further include one or more processors. One of the one or more processors in the processing component 922 may be configured to implement the indication information reception method described in any one of the foregoing examples.

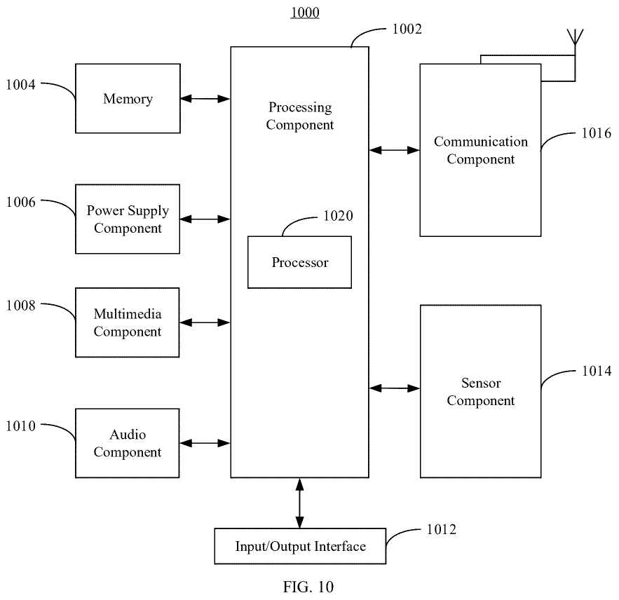

FIG. 10 illustrates a schematic block diagram of a device 1000 for indicating a precoding matrix according to an example of the present disclosure. For example, the device 1000 may be a terminal, such as a mobile phone, a computer, a digital broadcasting terminal, a messaging device, a game console, a tablet device, a medical device, a fitness device, or a personal digital assistant.

Referring to FIG. 10, the device 1000 may include one or more of the following components: a processing component 1002, a memory 1004, a power supply component 1006, a multimedia component 1008, an audio component 1010, an input/output (I/O) interface 1012, a sensor component 1014, and a communication component 1016.

The processing component 1002 generally controls the overall operations of the device 1000, such as operations associated with display, phone calls, data communications, camera operations, and recording operations. The processing component 1002 may include one or more processors 1020 to execute instructions to complete all or a part of the steps of the precoding matrix indication method performed by the terminal in any one of the foregoing examples. In addition, the processing component 1002 may include one or more modules that facilitate the interaction between the processing component 1002 and other components. For example, the processing component 1002 may include a multimedia module to facilitate the interaction between the multimedia component 1008 and the processing component 1002.

The memory 1004 is configured to store various types of data to support the operations of the device 1000. Examples of such data include instructions for any application or method operated on the device 1000, contact data, phonebook data, messages, pictures, videos, and the like.

The power supply component 1006 provides power for various components of the device 1000. The power supply component 1006 may include a power management system, one or more power supplies, and other components associated with generating, managing, and distributing power for the device 1000.

The multimedia component 1008 includes a screen providing an output interface between the device 1000 and a user. In some examples, the screen may include a liquid crystal display (LCD) and a touch panel (TP). If the screen includes the TP, the screen may be implemented as a touch screen to receive input signals from the user.

The audio component 1010 is configured to output and/or input audio signals. For example, the audio component 1010 includes a microphone (MIC) that is configured to receive external audio signals when the device 1000 is in an operating mode, such as a call mode, a recording mode, and a voice recognition mode. The received audio signals may be further stored in memory 1004 or transmitted via communication component 1016. In some examples, the audio component 1010 also includes a speaker for outputting audio signals.

The I/O interface 1012 provides an interface between the processing component 1002 and a peripheral interface module. The peripheral interface module may be a keyboard, a click wheel, buttons, or the like. These buttons may include, but are not limited to, a home button, a volume button, a start button, and a lock button.

The sensor component 1014 includes one or more sensors to provide the device 1000 with status assessments in various aspects.

The communication component 1016 is configured to facilitate wired or wireless communication between the device 1000 and other devices. The device 1000 may access a wireless network based on a communication standard, such as WiFi, 2G, 3G, 4G LTE, 5G NR, or a combination thereof. In an example, the communication component 1016 receives broadcast signals or broadcast-related information from an external broadcast management system via a broadcast channel. In an example, the communication component 1016 also includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth® (BT) technology, and other technologies.

In one or more examples, the device 1000 may be implemented by one or more application specific integrated circuits (ASICs), digital signal processors (DSPs), digital signal processing equipment (DSPD), programmable logic devices (PLDs), field programmable gate arrays (FPGAs), controllers, microcontrollers, microprocessors, or other electronics to perform the precoding matrix indication method performed by the terminal according to any one of the foregoing examples.

In one or more examples, a non-transitory computer-readable storage medium including instructions is also provided, such as the memory 1004 including instructions. These instructions may be executed by the one or more processors 1020 of the device 1000 to complete the precoding matrix indication method performed by the terminal according to any one of the foregoing examples. For example, the non-transitory computer-readable storage medium may be a ROM, a random access memory (RAM), a CD-ROM, a magnetic tape, a floppy disk, an optical data storage device, and the like.

Other implementations of the present disclosure will be readily apparent to those skilled in the art after implementing the disclosure by referring to the specification. The present disclosure is intended to cover any variations, uses, or adaptations of the present disclosure that are in accordance with the general principles thereof and include common general knowledge or conventional technical means in the art that are not disclosed in the present disclosure. The description and the examples are only illustrative, and the true scope and spirit of the present disclosure are set forth in the following claims.

It should be understood that the present disclosure is not limited to the above-described accurate structures illustrated in the drawings, and various modifications and changes can be made to the present disclosure without departing from the scope thereof. The scope of the present disclosure is to be limited only by the appended claims.

1. A precoding matrix indication method, performed by a terminal, comprising:
receiving configuration information of a distance from the terminal to a network device, which is sent by the network device;
determining indication information of a precoding matrix at least based on the configuration information of the distance; and
sending the indication information of the precoding matrix to the network device.

2. The method according to claim 1, wherein the configuration information of the distance comprises at least one of:
distance interval information; or
distance quantization step information.

3. The method according to claim 2,
wherein the distance interval information comprises at least one of:
an identifier corresponding to a distance interval,
a starting point of the distance interval,
an ending point of the distance interval, or
a length of the distance interval; or
wherein the distance quantization step information comprises at least one of:
a uniform quantization step, or
a non-uniform quantization step.

4. (canceled)

5. The method according to claim 3, wherein the method meets at least one of:
the uniform quantization step comprising one step for uniformly quantizing the distance interval; or
the non-uniform quantization step comprising an initial quantization step and one or more quantization step parameters, and being used for performing a non-uniform quantization on the distance interval, wherein a n-th quantization step among a plurality of quantization steps, stepₙ=f(n), with n being an integer and f(x) being a function determined according to the one or more quantization step parameters.

6. (canceled)

7. The method according to claim 1, wherein determining the indication information of the precoding matrix at least based on the configuration information of the distance comprises:
determining the indication information of the precoding matrix based on the configuration information of the distance and one or more codebook parameters.

8. The method according to claim 7, wherein determining the indication information of the precoding matrix based on the configuration information of the distance and the one or more codebook parameters comprises:
determining a codebook for the precoding matrix based on the configuration information of the distance and the one or more codebook parameters; and
determining the precoding matrix from the codebook according to channel information, and
wherein the indication information of the precoding matrix comprises at least an index of the determined precoding matrix.

9. The method according to claim 7, wherein determining the indication information of the precoding matrix based on the configuration information of the distance and the one or more codebook parameters comprises:
determining, according to channel information, a reference distance and a reference angle that meet a preset condition, and
wherein the indication information of the precoding matrix at least comprises reference distance information corresponding to the precoding matrix and reference angle information corresponding to the precoding matrix.

10. The method according to claim 9, wherein determining the indication information of the precoding matrix based on the configuration information of the distance and the one or more codebook parameters further comprises:
determining at least one reference distance and at least one reference angle corresponding to the precoding matrix based on the configuration information of the distance and the one or more codebook parameters, and
wherein the reference distance that meets the preset condition is a reference distance with a highest matching degree with the channel information among the at least one reference distance, and the reference angle that meets the preset condition is a reference angle with a highest matching degree with the channel information among the at least one reference angle.

11. The method according to claim 7, wherein the one or more codebook parameters comprise at least one of:
one or more parameters related to a 2-dimension (2D) discrete Fourier transform (DFT) codebook;
an angle range and an angle quantization step with respect to an antenna array of the network device in a first dimension; or
an angle range and an angle quantization step with respect to the antenna array of the network device in a second dimension.

12. (canceled)

13. An indication information reception method, performed by a network device, comprising:
sending, to a terminal, configuration information of a distance from the terminal to the network device; and
receiving indication information of a precoding matrix determined by the terminal at least based on the configuration information of the distance.

14. The method according to claim 13, wherein the configuration information of the distance comprises at least one of:
distance interval information; or
distance quantization step information.

15. The method according to claim 14,
wherein the distance interval information comprises at least one of:
an identifier corresponding to a distance interval,
a starting point of the distance interval,
an ending point of the distance interval, or
a length of the distance interval; or
wherein the distance quantization step information comprises at least one of:
a uniform quantization step, or
a non-uniform quantization step.

16. (canceled)

17. The method according to claim 16, wherein the method meets at least one of:
the uniform quantization step comprising one step for uniformly quantizing the distance interval; or
the non-uniform quantization step comprising an initial quantization step and one or more quantization step parameters, and being used for performing a non-uniform quantization on the distance interval, wherein a n-th quantization step among a plurality of quantization steps, stepₙ=f(n), with n being an integer and f(x) being a function determined according to the one or more quantization step parameters.

18. The method according to claim 13, wherein the indication information of the precoding matrix comprises at least one of:
an index of the precoding matrix;
reference distance information corresponding to the precoding matrix; or
reference angle information corresponding to the precoding matrix.

19. The method according to claim 13, further comprising:
sending one or more codebook parameters to the terminal.

20. The method according to claim 19,
wherein the configuration information of the distance and the one or more codebook parameters are used for determining a codebook for the precoding matrix; or
wherein the configuration information of the distance and the one or more codebook parameters are used for determining at least one reference distance and at least one reference angle corresponding to the precoding matrix.

21. (canceled)

22. The method according to claim 19, wherein the one or more codebook parameters comprise at least one of:
one or more parameters related to a 2-dimension (2D) discrete Fourier transform (DFT) codebook;
an angle range and an angle quantization step with respect to an antenna array of the network device in a first dimension; or
an angle range and an angle quantization step with respect to the antenna array of the network device in a second dimension.

23. The method according to claim 13, wherein the network device comprises at least one of:
a network control repeater;
a massive antenna array; or
a reconfigurable intelligent surface (RIS).

24-26. (canceled)

27. A communication device, comprising:
one or more processors; and
one or more memories for storing a computer program,
wherein the computer program, when executed by the one or more processors, implements:
receiving configuration information of a distance from a terminal to a network device, which is sent by the network device,
determining indication information of a precoding matrix at least based on the configuration information of the distance, and
sending the indication information of the precoding matrix to the network device.

28. A communication device, comprising:
one or more processors; and
one or more memories for storing a computer program,
wherein the computer program, when executed by the one or more processors, implements the indication information reception method according to claim 13.

29-30. (canceled)
